(19) United States
(12) Patent Application Publication
(10) Pub. No.: US 2008/0010531 A1
(43) Pub. Date: Jan. 10, 2008

(54) Classifying faults associated with a manufacturing process

(75) Inventors: Lawrence Hendler, Cupertino, CA (US); Uzi Josef Lev-Ami, Mountain View, CA (US)

Correspondence Address: PROSKAUER ROSE LLP, ONE INTERNATIONAL PLACE, BOSTON, MA, 02110, US

(73) Assignee: MKS Instruments, Inc., Wilmington, MA (US)

(21) Appl. No.: 11/451,223

(22) Filed: Jun. 12, 2006

(51) Int. Cl. G06F 11/00

(52) U.S. Cl. 714/33

(57) ABSTRACT

Faults that are associated with a set of variables that are each associated with a manufacturing parameter are classified. A fault vector is defined according to a multivariate analysis based on a contribution to a metric of a subset of the variables. The fault vector is compared to a plurality of previously-defined fault vectors to determine a comparison value indicative of a correlation between the fault vector and the plurality of previously-defined fault vectors. The fault vector is associated with at least one of a first set of fault vectors indicative of a known fault or a second set of fault vectors indicative of an unknown fault based in part on the comparison value.

### TECHNICAL FIELD

The invention generally relates to manufacturing processes and particularly to classifying faults associated with manufacturing processes.

### BACKGROUND

In the semiconductor device manufacturing industry, device manufacturers have managed to transition to more closely toleranced process and materials specifications by relying on process tool manufacturers to design better and/or faster process and hardware configurations. However, as device geometries shrink to the nanometer scale, complexity in manufacturing processes increases, and process and material specifications become more difficult to meet.

A typical process tool used in current semiconductor manufacturing can be described by a set of several thousand process variables. The variables are generally related to physical parameters of the manufacturing process and/or tools used in the manufacturing process. In some cases, of these several thousand variables, several hundred variables will be dynamic (e.g., changing in time during the manufacturing process or between manufacturing processes). The dynamic variables, for example, gas flow, gas pressure, delivered power, current, voltage, and temperature change based on, for example, a specific processing recipe, the particular step in the overall sequence of processing steps, or errors and faults that occur during the manufacturing process.

By way of example, if a given semiconductor wafer manufacturing process has 200 dynamic variables that are each sampled by a data acquisition system at a rate of one sample per second (or faster) and a wafer requires 30 seconds to process, the data acquisition system will acquire about 6,000 data points (or more). The difficulty for an operator monitoring the manufacturing process to detect a fault in the process increases as the number of data points increases. It is particularly difficult to detect faults by visual inspection because visual inspection involves subjectivity to determine if a fault exists. More specifically, it is difficult for an operator to review raw data traces plotted on a display for each of the 200 variables to draw certain conclusions. Such conclusions include, for example, whether the process is properly progressing or whether a fault has occurred in the process. Faults occur, for example, when a tool used in wafer processing malfunctions or performs sub-optimally.

Management of such a large amount of data involved in process control is a formidable task. As the volume of wafers produced in a particular manufacturing facility increases, the available information related to the process conditions also increases. Hence, it becomes desirable to control and manage this information to determine the cause of a particular type of wafer defect. After the cause of a particular problem is determined, an operator is able to deploy a solution or corrective action to remedy the problem. Managing such a large amount of information is further complicated if wafers are processed according to different recipes. Recipes may change from wafer to wafer due to, for example, using different process steps, arranging process steps in a different order, or varying parameters or parameter values within each process step.

### SUMMARY

There is a need for improved methods and systems for monitoring manufacturing processes and the information related to the manufacturing processes. Furthermore, there is a need to use the information acquired to improve manufacturing processes at the individual process or tool level. There is a need to determine a substantially recipe-independent cause of particular process outputs (e.g., faults). Additionally, there is a need to define corrective actions based on the process information previously gathered. The need can be met through an automated arrangement that minimizes the potential for human error when dealing with large and complicated data sets.

A fault detection and classification system can be used to analyze and characterize faults that occur during wafer processing. As time progresses, a database of faults that have occurred can be constructed. The database includes a record of manufacturing variables (e.g., physical features or operating parameters) associated with a particular type of fault. Additionally, the database includes a record of the corrective action that was taken to cure the fault. In this way, for real-time wafer processing, variables associated with a particular wafer processing recipe can be monitored. If a particular set of values of a set of measured variables resembles a previously-measured set of variables stored in the database, the type of fault responsible for the measured variables can be determined. In general, similar faults will be associated with similar patterns of values for the variables (e.g., the processing parameters).

In one aspect, the invention relates to a method for classifying faults associated with a manufacturing process. The method involves determining that a fault exists when at least one of a T² score exceeds a predetermined T² critical value or a DModX score exceeds a predetermined DModX critical value. The T² score is calculated based on a Hotelling-type calculation performed on a first subset of a plurality of manufacturing process-related variables. The DModX score is calculated based on a DModX-type calculation performed on a second subset of the plurality of manufacturing process-related variables. The method involves generating fault vectors for each of the calculation types performed in which the corresponding score exceeds the corresponding critical value. The method also involves comparing the generated fault vectors to a plurality of corresponding, previously-defined fault vectors to determine a comparison value. The comparison value is indicative of a correlation between the generated fault vectors and the plurality of corresponding, previously-defined fault vectors. The method also involves associating each of the generated fault vectors with at least one of a first class of vectors indicative of a known fault or a second class of vectors indicative of an unknown fault based in part on the comparison value.

In another aspect, invention relates to a method for classifying a fault associated with a set of variables. Each member of the set of variables is associated with a manufacturing parameter. The method involves defining a fault vector according to a multivariate analysis based on a contribution of a subset of the set of variables to a metric. The method involves comparing the fault vector to a plurality of previously-defined fault vectors to determine a comparison value indicative of a correlation between the fault vector and the plurality of previously-defined vectors. The method involves associating the fault vector with at least one of a first set of fault vectors indicative of a known fault or a second set of fault vectors indicative of an unknown fault based in part on the comparison value.

In some embodiments, associating the fault vector with the first or second sets of fault vectors involves determining if a subset of values of the fault vector satisfies a predetermined criterion. The subset of values of the fault vector can include values that contribute to the comparison value, and the predetermined criterion can include whether a calculation based on the subset of values of the fault vector is above a predetermined threshold. In some embodiments, the subset of values of the fault vector includes values that do not contribute to the comparison value, and the predetermined criterion includes whether a calculation based on the subset of values of the fault vector is below a predetermined criterion. In some embodiments, the manufacturing parameters are measured in a semiconductor wafer processing facility.

In some embodiments, the plurality of previously-defined fault vectors is associated with a representative fault vector. The representative fault vector includes an average contribution of each of the set of variables to the metric, the average contribution based on individual contributions of each of the set of variables to each of the fault vectors in the first set of fault vectors. Each of the individual contributions can be assigned a statistical weight, and the average contribution of each of the set of variables to the score is calculated according to a weighted average method. The comparison value can be determined based in part on a comparison between the fault vector and the representative vector.

In some embodiments, a predetermined criterion is determined by a user. In some embodiments, prior to defining the fault vector, the method involves determining a fault exists when a value, calculated based on a mathematical expression performed on the set of variables, exceeds a critical value. In some embodiments, the method involves determining that the fault exists when at least one of a first value exceeds a first critical value or a second value exceeds a second critical value. The first value is calculated based on a Hotelling-type calculation performed on the set of variables. The second value is calculated based on a DModX-type calculation performed on the set of variables. The metric can include the first value, the second value, or both.

In some embodiments, the comparison value is determined according to Pearson's correlation equation. The fault vector can be associated with the first set of fault vectors when the comparison value exceeds a predetermined value or threshold. The predetermined value or threshold can be determined by a user. In some embodiments, the first set of fault vectors is associated with an attribute indicative of a type of fault vector that is associated with the first set of fault vectors. Associating the fault vector with the first set of fault vectors can include modifying the attribute.

In some embodiments, the fault vector is associated with the second set of fault vectors when the comparison value does not exceed a predetermined value. The second set of fault vectors can include an empty set before the fault vector is associated with the second set of fault vectors. In some embodiments, associating the fault vector with the second set of fault vectors includes establishing or creating the second set of fault vectors.

In some embodiments, the method involves determining an action to correct the fault based in part on whether the fault vector is associated with the first set of fault vectors or the second set of fault vectors. The method can include associating an attribute indicative of a type of fault with the second set of fault vectors. In some embodiments, the method involves, prior to defining the fault vector, analyzing previously-acquired data to define the plurality of previously-defined vectors, the previously-acquired data provided by a data mining application.

In another aspect, the invention features a system for classifying a fault associated with a set of variables each associated with a manufacturing parameter. The system includes a means for defining a fault vector according to a multivariate analysis based on a contribution of a subset of the set of variables to a metric. The system includes a means for comparing the fault vector to a plurality of previously-defined vectors to determine a comparison value indicative of a correlation between the fault vector and the plurality of previously-defined vectors. The system also includes a means for associating the fault vector with at least one of a first set of fault vectors indicative of a known fault or a second set of fault vectors indicative of an unknown fault based in part on the comparison value.

In some embodiments, the system includes a means for determining the fault exists when at least one of a first value exceeds a first critical value or a second value exceeds a second critical value. The first value is calculated based on a Hotelling-type calculation performed on the set of variables. The second value is calculated based on a DModX-type calculation performed on the set of variables.

In another aspect, the invention features a computer program product, tangibly embodied in an information carrier, including instructions operable to cause data processing apparatus to define a fault vector according to a multivariate analysis based on a contribution to a metric of a subset of a set of variables each associated with a manufacturing parameter. The instructions are operable to cause data processing apparatus to compare the fault vector to a plurality of previously-defined vectors to determine a comparison value indicative of a correlation between the fault vector and the plurality of previously-defined vectors. The instructions are operable to cause data processing apparatus to associate the fault vector with at least one of a first set of fault vectors indicative of a known fault or a second set of fault vectors indicative of an unknown fault based in part on the comparison value.

In some embodiments, the computer program product includes instructions operable to cause data processing apparatus to determine the fault exists when at least one of a first value exceeds a first critical value or a second value exceeds a second critical value. The first value is calculated based on a Hotelling-type calculation performed on the set of variables. The second value is calculated based on a DModX-type calculation performed on the set of variables.

The invention, in any of the above aspects, can include additional features. In one embodiment, the invention includes all of the above features.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram of a system for classifying faults associated with a manufacturing process, according to an illustrative embodiment of the invention.

FIG. 2 is a flow chart depicting a computer implementation of steps used to determine that a fault exists, according to an illustrative embodiment of the invention.

FIG. 3 is a flow chart illustrating steps used to classify a fault after the fault has been determined to exist, according to an illustrative embodiment of the invention.

FIG. 4 is a flow chart illustrating steps used to classify a fault after the fault has been determined to exist, according to an alternative embodiment of the invention.

FIG. 5 is a flow chart illustrating steps used to classify a fault after the fault has been determined to exist, according to an alternative embodiment of the invention.

### DETAILED DESCRIPTION

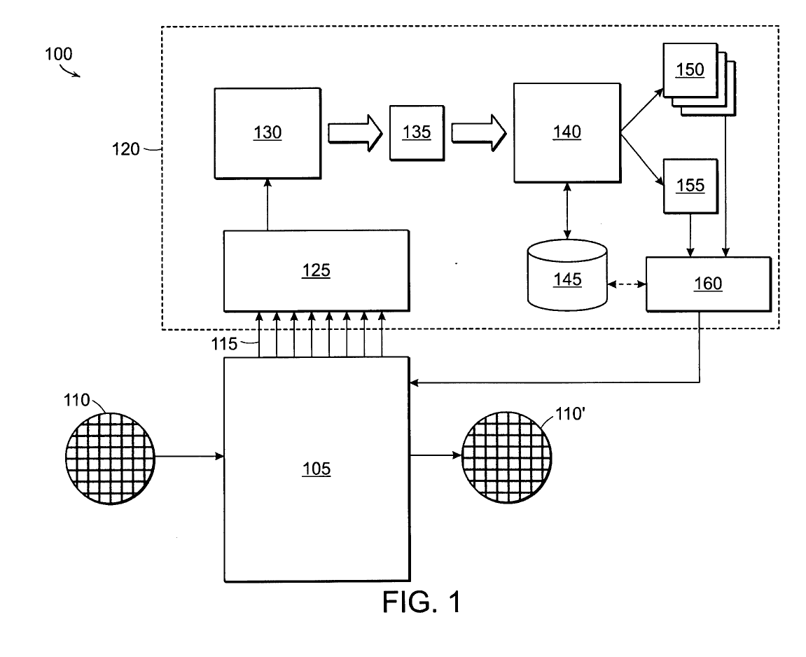

FIG. 1 is a block diagram of a system 100 for classifying faults associated with a manufacturing process, according to an illustrative embodiment of the invention. The system 100 includes a processing facility 105 for performing wafer processing functions on wafer 110 and outputting a processed wafer 110′. The processing facility 105 can include tools or processes (not shown) for, for example, cleaning wafers, depositing material on wafers, removing material from wafer surfaces, and performing other functions within the processing facility 105. In some embodiments, the tools or processes include multiple stations or units within the facility 105. These functions can be associated with a plurality of physical parameters, for example, gas pressure, gas flow rate, temperature, time, and/or plasma concentration among many others. In some embodiments, the parameter is the yield loss of the particular wafer 110 that occurs after processing. The physical parameters can be monitored and manipulated to produce a plurality of outputs 115 containing data about the variables (e.g., the physical parameters and/or tool operating conditions) in the processing facility 105. The outputs 115 can be electrical, optical, magnetic, acoustic, or other signals capable of transmitting the data to a processor 120. For example, temperature within a processing chamber is a variable that can be measured for purposes of identifying whether a wafer is faulty. The temperature may vary during operation and/or under different process conditions. Although the system 100 is described in the context of processing the wafer 110, other manufacturing processes are contemplated and within the scope and spirit of the invention.

The processing facility 105 is coupled to the processor 120 by a data acquisition module 125. The data acquisition module 125 receives the outputs 115 from the processing facility 105. In some embodiments, the data acquisition module 125 performs buffering, multiplexing, signaling, switching, routing, formatting, and other functions on the data to put the data in a format or condition for suitable communication or retransmission to other modules of the processor 120.

The data acquisition module 125 is coupled to a fault determining module 130 for determining whether a fault exists in the processing apparatus 105 or on the wafer 110. The fault-determining module 130 performs a mathematical calculation on the data received from the data acquisition module 125 to determine a value (or score). When the calculated value exceeds a critical value (e.g., a predetermined critical value), a fault or fault condition is determined to exist.

In some embodiments, the value is determined based on a multivariate and/or statistical analysis. An example of a suitable mathematical calculation is a Hotelling-type calculation that is used to determine a T² score. A T² score can be calculated according to the following equation:

$${T}^{2} = {( \frac{\overline{x} - {μ}_{0}}{σ} )}^{T} {S}^{- 1} ( \frac{\overline{x} - {μ}_{0}}{σ} ) \text{where:} \\ σ = standard deviation for a particular variable , \\ based on data acquired for previous wafers , \\ \overline{x} = [ \begin{matrix}{\overline{x}}_{1} \\ {\overline{x}}_{2} \\ ⋮ \\ {\overline{x}}_{p}\end{matrix} ] , \\ measured value of parameters , for p variables , \\ {μ}_{0} = [ \begin{matrix}{μ}_{1}^{0} \\ {μ}_{2}^{0} \\ ⋮ \\ {μ}_{p}^{0}\end{matrix} ] , \\ mean value of parameters based on previous wafers , \\ for p variables \qquad \text{Equation 1}$$

S⁻¹=an inverse correlation matrix, which is the inverse of the covariance matrix, S, illustrated below:

$$S = [ \begin{matrix}{\overline{S}}_{1}^{2} & {\overline{S}}_{12} & {\overline{S}}_{13} & ⋯ & {\overline{S}}_{1 p} \\ & {\overline{S} }_{2}^{2} & {\overline{S}}_{23} & ⋯ & {\overline{S}}_{2 p} \\ & & {\overline{S} }_{3}^{2} & ⋯ & {\overline{S}}_{3 p} \\ & & & ⋰ & ⋮ \\ & & & & {{S}^{\_\_}}_{p}^{2}\end{matrix} ] \text{where:}$$

$${S}_{ij} = \frac{1}{N - 1} {\sum }_{i = 1}^{k} {\sum }_{j = 1}^{{n}_{i}} ( {x}_{ij} - \overline{x} ) {( {x}_{ij} - \overline{x} )}^{T} , \\ where indices i and j identify the matrix$$

element for both S and x in a generalized k×n matrix.

In general, a T² score is a calculation of the weighted distance of manufacturing process variables for an output (e.g., the wafer 110′) of the manufacturing process relative to an output produced under normal process operation. One way to understand the meaning of the T² value is to consider it in terms of a geometric description. A normal manufacturing process is a cluster of data points in an n-dimensional space, where n is the number of measured manufacturing process variables. T² is the squared distance of a new output from the center of this cluster of data points weighted relative to the variation output of the in the normal process condition. The variation is often illustrated as an n-dimensional hyper-ellipse that bounds the cluster of data points. In general, Hotelling-type calculations can be used to, for example, determine whether a particular point is an outlier (e.g., outside the hyper-ellipse) with respect to the remainder of the data set. More specifically, a Hotelling-type calculation can be used to determine whether a particular measured parameter is outside an alarm limit, as determined by a mathematical model for the process parameters being observed. When a calculated T² score exceeds a threshold T² score, a fault or fault condition is determined to exist. A threshold T² score can be selected by an operator to be, for example, a T² score greater than the maximum T² score calculated for known good wafers (not shown).

Another example of a suitable mathematical calculation is a DModX-type calculation. A DModX-type calculation involves calculating the distance of a particular data point from a location in an n-dimensional space that represents a preferred location (e.g., a location associated with an ideal wafer). The DModX value is calculated using a principal component analysis that maps the n-dimensional variable to a lower order (e.g., less than order n) dimensional variable. Mathematically, the DModX value is the orthogonal component (or residue) resulting from the principal component analysis. A DModX value can be indicative of a range of values (e.g., a “tolerance volume”) about a particular variable (e.g., a data point) in the mathematical model. Similarly to the Hotelling-type calculation, when the calculated DModX score exceeds a threshold DModX score, a fault or fault condition is determined to exist. In some embodiments, the threshold score (e.g., for the T² score or DModX score) is user-configurable to allow an operator to determine, quantify, or define when a fault exists.

The fault determining module 130 creates a fault vector 135 after identifying the existence of a fault. The fault vector 135 is a vector of values that correspond to the values used to calculate the fault score (e.g., T² score or DModX score). Each value in the fault vector 135 is associated with a process parameter of the manufacturing process and represents the contribution of an individual process parameter to the fault score. In some embodiments, the contribution values are assigned a statistical weight for subsequent calculation. The fault vector 135 can be defined, for example, using a multivariate calculation. An example of a multivariate calculation engine that can perform the multivariate calculation to define a fault vector is the SIMCA® P+ or SIMCA® QP+ software applications sold by Umetrics, Inc. of Umea, Sweden. Other commercially available software applications can be used to define a fault vector, for example, MATHEMATICA® sold by Wolfram Research, Inc. of Champaign, Ill., MATLAB® sold by The MathWorks, Inc. of Natick, Mass.; JMP® sold by SAS Institute, Inc. of Cary, N.C., or other general purpose statistical software products.

The fault vector 135 is analyzed by a correlation module 140 that is in communication with a database 145 that contains previously-defined fault vectors (not shown). The correlation module 140 performs a correlation calculation that compares the fault vector 135 to the previously-defined fault vectors in the database 145. The correlation module 140 makes a comparison between the contributions to the fault vector 135 by various physical parameters and the contributions to the previously-defined fault vectors in the database 145 by the physical parameters. In some embodiments, the contributions to the fault vector 135 are compared to a representative fault vector (not shown). The representative fault vector can include the average value of contributions from all or a subset of the previously-defined vectors. The representative fault vector can be defined from the contents of the database 145 or from a set 150 of fault vectors indicative of a known fault. Contributions from the plurality of previously-defined vectors can be assigned a statistical weight when defining the representative fault vector. The representative fault vector can be calculated from a statistically weighted average of the plurality of previously-defined vectors.

In some embodiments, the set 150 of fault vectors are logically associated and have similar attributes or characteristics. The attribute or characteristic can be, for example, a known fault and include a known corrective action for the particular fault. The correlation calculation can be performed by the correlation module 140 according to Pearson's correlation equation, which is sometimes called Pearson's product moment correlation. Pearson's correlation equation is shown below as Equation 2.

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}} \qquad \text{Equation 2}$$

In Pearson's correlation equation, r is the comparison value (sometimes referred to as a correlation value) and quantifies the degree of linear relationship between two multi-component metrics. The two multi-component metrics are represented in Equation 2 by variables, x and y, which are substantially normally distributed about mean values x̅ and y̅, respectively. In some embodiments, the two variables, x and y, represent independent random variables. The variables can be continuous or discrete. The degree of linear relationship between a first multi-component metric to a second multi-component metric is calculated on a component-by-component basis. More specifically, each i^{th} component of the first multi-component metric (e.g., the fault vector 135) is compared to a corresponding component of the second multi-component metric (e.g., the previously-defined vectors in the database 145 or the set 150) to determine the comparison value, r. As used herein, the terms “set” and “class” each refer to a logical grouping of fault vectors based on, for example, similar attributes or characteristics.

When the comparison value, r, calculated by the correlation module 140 exceeds a threshold comparison score, r_{crit}, the fault vector 135 is associated with the previously-defined fault vectors. In some embodiments, the fault vector 135 is associated with the set 150 of fault vectors having known corrective action when the comparison value, r, exceeds the threshold comparison score, r_{crit}. In some embodiments, the threshold comparison score, r_{crit}, can be determined or configured by a user through, for example, an interface with the correlation module 140 (e.g., via a graphical user interface that controls the value of the threshold comparison score, r_{crit}). The correlation module 140 can associate the fault vector 135 with the set 150, or a different module (not shown) can perform the associating function.

In some embodiments, the components of the first multi-component metric (e.g., the fault vector 135) do not correspond on a one-to-one basis with those of the second multi-component metric. For example, some components of the fault vector 135 may not overlap with the components of the second multi-component metric. In such embodiments, a common subset of the components of the first multi-component metric and the second multi-component metric are compared to determine a correlation value. The subset is chosen to include components in common with the second multi-component metric. The first and second common subsets can be determined by the correlation module 140, or other components of the system 100. For example, the first common subset can include sub-vectors or sub-components of the fault vector 135 common to the previously-defined vectors in the database 145 or the set 150. More specifically, the correlation module 140 compares components of the subsets rather than the components of the vectors. Methods employed by the correlation module 140 are discussed further below.

In some embodiments, the comparison value, r, does not exceed the threshold comparison value, r_{crit}. In such an embodiment, the fault vector 135 is associated with a set 155 of vectors indicative of an unknown fault. The set 155 can include one or more fault vectors that have not been associated with the first set 150 or any other set of fault vectors. In some embodiments, associating the fault vector 135 with the set 155 involves establishing or creating the set 155. For example, when the correlation module 140 determines that the comparison value, r, relating the fault vector 135 to the database 145 or the set 150 does not exceed r_{crit}, the set 155 is created. The set 155 can be created, for example, by generating a record in the database 145 including the attributes associated with the vectors in the set 155. In some embodiments, the set 155 exists but is an empty set until the fault vector 135 is associated therewith.

A corrective action (that can be performed to remedy a fault) is an example of an attribute that can be associated with the set 150 of fault vectors indicative of a known fault. For example, an operator or user may understand based on previous wafer processing that a particular set of fault vectors (e.g., the set 150) indicates that a particular processing tool in the facility 105 is malfunctioning, and that a particular corrective action will remedy the malfunction. Knowledge of the attributes associated with the set 150 allows the operator to quickly assess and implement corrective actions to prevent further faulty or defective wafers. The processor 120 includes a corrective action module 160. The corrective action module 160 stores information that associates a particular set of fault vectors (e.g., the set 150) with a particular corrective action via, for example, a look-up table. The corrective action module 160 is in communication with the set 150 of fault vectors and the facility 105. In some embodiments, the corrective action module 160 is in communication with the database 145. Some or all of the corrective action data can be stored in the database 145.

The processor 120 communicates with the corrective action module 160 when a particular fault vector (e.g., the fault vector 135) has been added to the set 150. The corrective action module 160 can determine and communicate an appropriate corrective action to the operator (or an automatic controller) of the facility 105. In some embodiments, the facility 105 automatically implements the corrective action (e.g., without intervention by the operator). The corrective action module 160 also communicates with the set 155 of vectors indicative of unknown faults. As increasing numbers of wafers 110 are processed, the set 155 can be associated with a known fault (e.g., adaptively through repeated exposure to processing outputs and associated corrective actions). In such embodiments, the set 155 communicates with the corrective action module 160 in a similar manner as described above for the set 150.

In some embodiments, the function performed by the corrective action module 160 is performed by an operator. A human or a machine can be used to associate the set of vectors 150 with a fault and/or a corrective action and with implementing the corrective action via the facility 105. In such embodiments, the output of the processor 120 is displayed to the operator (e.g., via a visual display to the human or as an input signal to the machine).

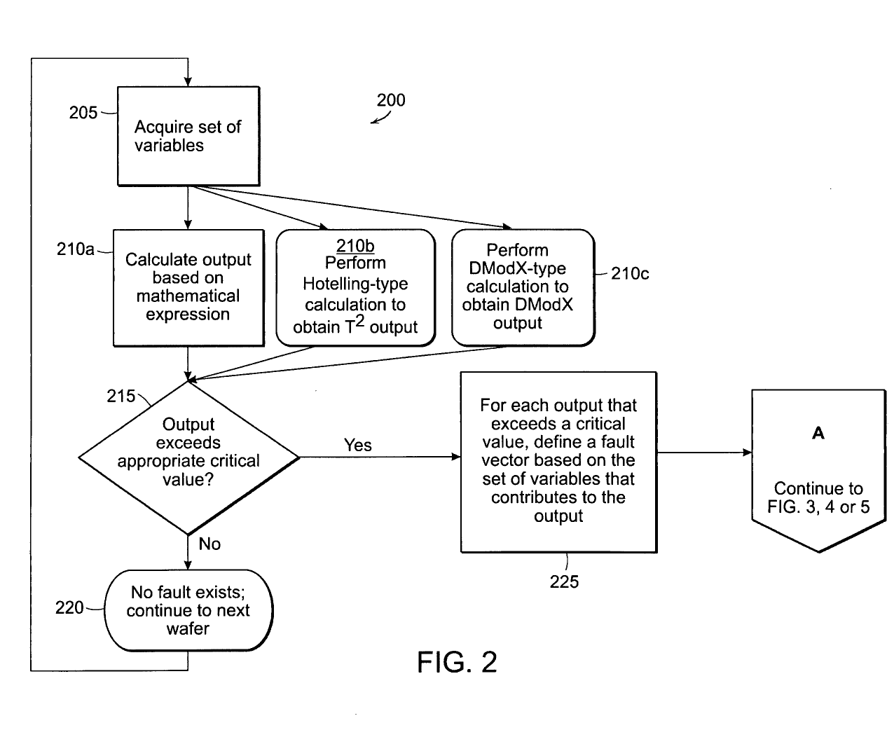

FIG. 2 is a flow chart depicting a computer implementation of steps used to determine that a fault exists, according to an illustrative embodiment of the invention. The method 200 illustrated in FIG. 2 can take the form of a computer program or a computer program product that is tangibly embodied in an information carrier and that includes instructions operable to cause data processing apparatus to perform the individual steps in the method 200. In step 205, a set of variables is acquired. In this embodiment, the set of variables includes physical parameters associated with wafer processing. In steps 210a, 210b, and 210c (generally step 210), a mathematical expression is applied to the set of variables, for example, by performing a calculation involving the set of variables as inputs or parameters to the mathematical expression. Step 210a represents a step in the method during which a general mathematical expression operates on the set of variables (of step 205) to produce an output. The mathematical expression implemented in step 210a can be a probabilistic or statistical calculation. In some embodiments, the mathematical expression that is implemented relates to determining process controls or alarm limits based on the set of variables acquired in step 205.

Step 210b can be performed alternatively to, or in addition to, step 210a. Step 210b involves performing a Hotelling-type calculation on the set of variables (step 205) to generate a T² score as an output. Step 210c can be performed alternatively to, or in addition to, step 210a and/or step 210b. Step 210c involves performing a DModX-type calculation on the set of variables (variables acquired in step 205) to generate a DModX score as an output. The outputs of steps 210a, 210b, and 210c are provided to step 215.

In step 215, each output that is generated in step 210 is compared to the appropriate critical or threshold value. In particular, the T² output of step 210b is compared to a T² critical value. Similarly, the DModX output of step 210c is compared to a DModX critical value. If the particular output of step 210 does not exceed the corresponding critical value, no fault is determined to exist (e.g., step 220) and the next wafer is processed (e.g., returning to step 205 to acquire values of a set of variables for a new wafer).

If the particular output of step 210 does exceed the corresponding critical value, a fault is determined to exist for the output, shown in step 225. More particularly, when the T² output exceeds the T² critical value in step 215, a fault vector is defined in step 225. Similarly, when the DModX output exceeds the DModX critical value in step 215, a second fault vector is defined in step 225. In this way, a single set of variables can result in multiple fault vectors being defined. The number of fault vectors defined depends on the number of outputs of step 210 that exceed the corresponding critical value.

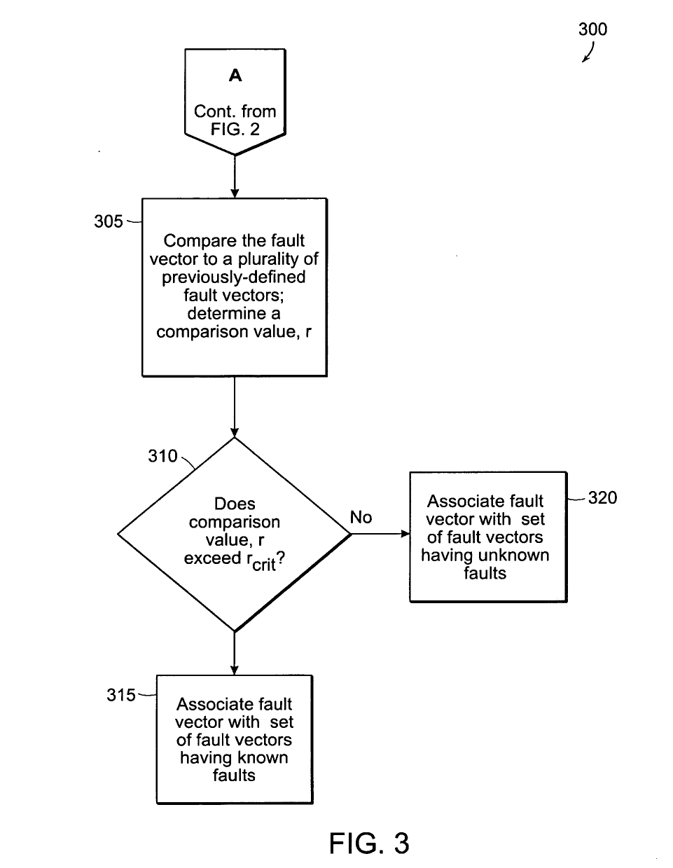

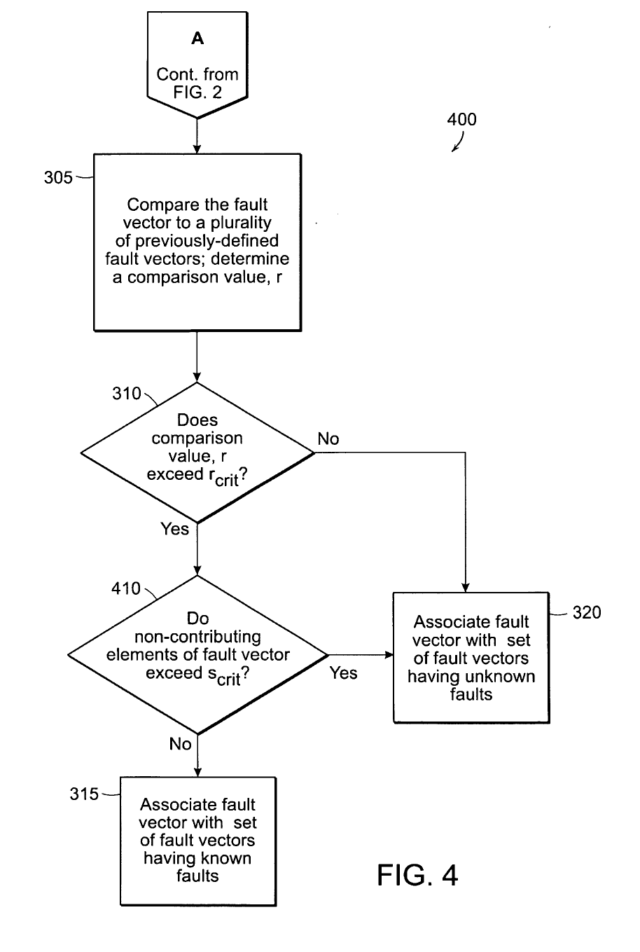

In some embodiments, in step 225, the fault vector is defined based on a subset of the set of variables (e.g., the entire set or a subset) that contribute to the particular output of step 210. More particularly, a particular subset of the set of variables acquired in step 205 can be chosen or down-selected to be used in calculating the T² output (in, for example, step 210b). The fault vector associated with the T² output is therefore defined based on that subset of variables. Similarly, a second, different subset of the variables acquired in step 205 can be chosen or down-selected to be used in calculating the DModX output (in, for example, step 210c). The fault vector associated with the DModX output is therefore defined based on the second subset of variables. The fault vector can be defined, for example, using a multivariate analysis to establish a metric that includes the particular subset or the entire set of variables used to determine that the fault exists. Examples of suitable multivariate analyses are discussed above with respect to FIG. 1. When one or more fault vectors have been defined in step 225, the method 200 continues to subsequent embodiments of the invention via box A (e.g., to one of FIGS. 3, 4, or 5).

FIG. 3 is a flow chart illustrating steps used to classify a fault after the fault has been determined to exist, according to an illustrative embodiment of the invention. The method 300 of FIG. 3 begins at box A, carried over from the method 200 of FIG. 2. In step 305, each fault vector that was defined in step 225 of FIG. 2 is compared to a plurality of previously-defined fault vectors, and a comparison value, r, is determined. The comparison value, r, is determined from Pearson's correlation equation as described previously herein. Other expressions or correlation formulae can also be used to determine the comparison value, r. Each component of the fault vector is compared to each corresponding component of a plurality of previously-defined vectors to determine a comparison value, r, that is indicative of the relationship between the fault vector and the previously-defined fault vectors. In some embodiments, the vectors do not have identical components. In these embodiments, a subset of components that are common to both the defined fault vector and the previously-defined vectors are instead used in calculating the comparison value, r. In some embodiments, the plurality of previously-defined fault vectors constitutes a set of fault vectors indicative of a known fault.

In step 310, the comparison value, r, is compared to a threshold comparison value, r_{crit}. If the comparison value, r, exceeds r_{crit}, the defined fault vector is associated with that particular set of fault vectors in step 315. The defined fault vector is then added to the set of previously-defined fault vectors for processing of subsequent wafers. A feature of this embodiment involves associating the fault or type of fault associated with a particular vector. The attributes of the defined fault vector are thus determined by the attribute or attributes of the set of previously-defined fault vectors. For example, an attribute associated with a set of fault vectors can be the corrective action necessary to remedy and/or prevent future faults of that type. After a defined fault vector is associated with that set of fault vectors, the necessary corrective action can be determined from the attribute.

However, if the comparison value, r, does not exceed r_{crit}, the defined fault vector is associated with a set of fault vectors having unknown faults in step 320. For example, the attribute associated with the set of vectors in step 320 can be an unknown correction action or an unknown cause of the fault. In some embodiments, step 320 involves associating the fault vector with an empty set. Step 320 can also involve creating or establishing the set of fault vectors indicative of an unknown fault.

FIG. 4 is a flow chart illustrating steps used to classify a fault after the fault has been determined to exist, according to an alternative embodiment of the invention. The method 400 of FIG. 4 differs from the method 300 of FIG. 3 by the addition of step 410. According to the method 400 if the comparison value, r, exceeds r_{crit}, the defined fault vector is not immediately associated with that particular set of fault vectors in step 315. Rather, the method 400 first proceeds to step 410. As discussed above, in some correlation calculations, some components of the defined fault vector are not identical to the components of the previously-defined fault vectors. In such embodiments, a subset of the components is used to determine the comparison value, r.

In step 410, the uncommon or nonoverlapping components of the vectors are evaluated. In particular, a calculation is performed on the nonoverlapping (also referred to as non-contributing) components to determine a noise value, s. In some embodiments, the noise value, s, is calculated according to Equation 3:

$$s = \frac{\sum non \text{-} overlapping component contributions}{\sum all component contributions} \qquad \text{Equation 3}$$

If the value of s exceeds a threshold minimum value, s_{crit}, the method 400 does not advance to step 315. More particularly, if the noise value, s, is above a desirable level, the accuracy of the comparison value, r, may not be relied upon, because the noise value, s, reduces the accuracy of the comparison value, r, beyond a level acceptable to an operator. When the value of s exceeds s_{crit}, the defined fault vector is instead associated with the set of vectors having unknown faults in step 320. Conversely, if the value of s is less than s_{crit}, the accuracy of the comparison value, r, may be relied upon, and the fault vector is associated with the set of fault vectors having known faults (step 315).

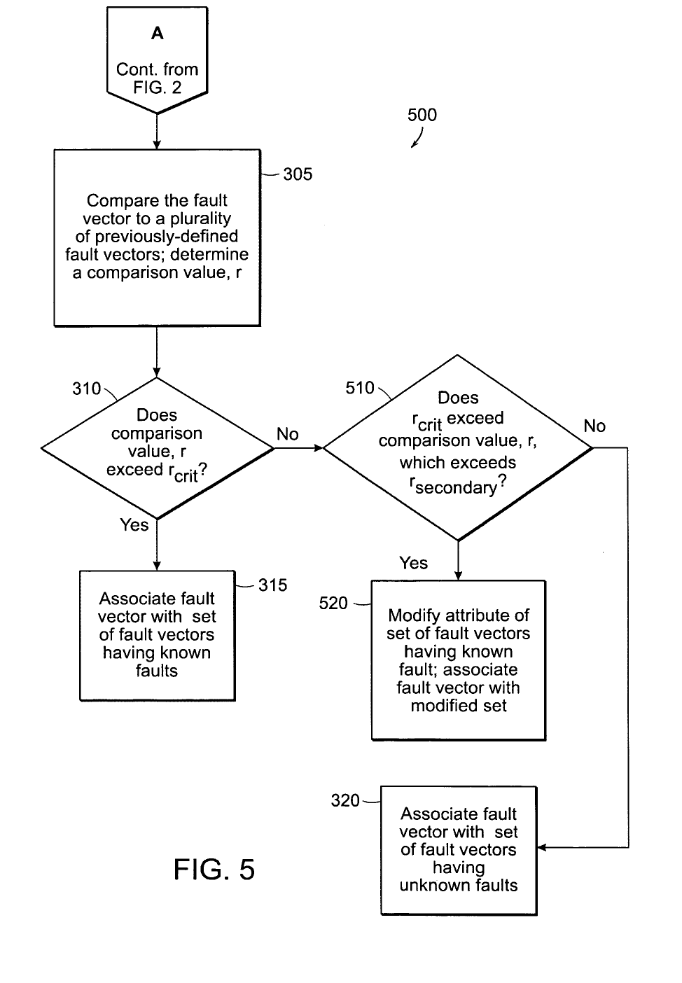

FIG. 5 is a flow chart illustrating steps used to classify a fault after the fault has been determined to exist, according to an alternative embodiment of the invention. The method 500 of FIG. 5 differs from the method 300 of FIG. 3 by the addition of steps 510 and 520. According to the method 500, when the comparison value, r, does not exceed r_{crit}, a subsequent comparison calculation is performed (step 510). In the subsequent comparison calculation (step 510), the calculated comparison value, r, is compared to a second value, r_{secondary}. The value of r_{secondary} is indicative of a correlation between one or more related sets of vectors whose fault vectors did not satisfy the criterion that the comparison value, r, exceeded the threshold, r_{crit}. In some embodiments, the result of the second comparison (step 510) satisfies the inequality, r_{secondary}<r <r_{crit}. When the inequality is satisfied, the defined fault vector is related to one or more sets of previously-defined vectors (e.g., more than one vector in the set 150 of FIG. 1). However, the defined fault vector is not sufficiently related to the one or more sets of previously-defined fault vectors to be associated with or included in the sets of previously-defined vectors. When the equality is satisfied, the method 500 advances to step 520.

In step 520, an attribute of one or more of the sets of previously-defined fault vectors is changed or modified. The defined fault vector is then associated with the one or more modified sets. In an embodiment of the invention involving two sets of previously-defined fault vectors, modifying the attribute can involve merging or combining two sets into a single set. The defined fault vector is then associated with the single set of previously-defined fault vectors. In some embodiments of the invention, modifying the attribute can involve dividing or splitting a single set of previously-defined fault vectors into two or more sets. The defined fault vector is then associated with each of the two or more sets of previously-defined fault vectors. Another embodiment of the invention involves modifying the attribute of the set, including changing a parameter used in comparing the defined fault vector to the set of previously-defined fault vectors. The defined fault vector is then compared to the modified set. For example, the mean or average value of the previously-defined fault vectors can be recalculated using the values from the defined fault vector. The fault vector is then compared to the set of previously-defined fault vectors with the modified mean value. In some embodiments, either r_{crit} or r_{secondary} or both are determined by a user or according to a desired parameter (e.g., associated with process control parameters).

In some embodiments, however, the comparison value, r, generated when a defined fault vector is compared to previously-defined vectors does not exceed either r_{crit} or r_{secondary} (step 520). In such embodiments, the defined fault vector is not closely related to the previously-defined fault vectors. The defined fault vector is associated with the set of fault vectors having unknown faults in step 320.

Various combinations and permutations of the techniques described herein are within the scope of the invention. For example, the above-described techniques for determining that a fault exists, for defining a fault vector, and for associating the fault vector with a set of fault vectors can be implemented on the process level or relative to a particular process step. At the process level, faults are detected and classified based on substantially all of the data collected during all of the processes involved in processing wafers (e.g., after processing has been completed). At the process step level, faults are detected and classified based on the data collected and analyzed during the particular process step, irrespective of other process steps (e.g., during wafer processing or during a particular process step). In some embodiments, the techniques described above permit an operator to analyze the collected data at the process level to determine whether a fault occurred during a particular process step. In this way, the process level data is associated with and provides insight into each of the process steps. In some embodiments, either the process-level data or the process step-level data is analyzed after wafer processing.

For example, data collected during wafer processing can be configured for either process-level or process-step-level fault detection and classification. In some embodiments, during a particular wafer processing step, the variables associated with the particular process step are monitored and acquired. A fault is determined to exist and a fault vector is defined based on this acquisition of variables. In some embodiments, the variables associated with all of the steps in the process are monitored and acquired. The variables can then be organized, for example, by variable-type. For example, all of the temperature variables acquired from a particular tool can be associated with each other (e.g., summed or integrated), irrespective of whether, for example, particular variables are acquired during a particular process step. A fault is then determined to exist and a fault vector is defined based on the acquisition of all of the variables.

In some embodiments, at either the process-level or the particular process-step-level, the variables are logically organized according to a particular tool or process that is used. For example, if a variable (e.g., temperature or pressure) is measured at each of four zones of a particular wall in a particular tool chamber, the four variables can be logically associated with each other to form a single pseudo-variable representing the contribution of the wall temperature to, for example, a fault condition. The pseudo-variable is then used for fault determination and classification. Using a pseudo-variable is desirable in some instances because the number of non-overlapping parameters (e.g., factors contributing to the noise value, s) is reduced.

The concepts described herein can also be implemented in existing manufacturing facilities. For example, a data mining application (not shown) can be used to determine the sets of previously-defined vectors based on previous wafer processing and data acquired during such processing. Data mining refers to, for example, searching large quantities of data in databases to discern patterns. In this way, the concepts as described are backwards-compatible with existing systems that monitor manufacturing processes. The data mining application provides previously-gathered data to, for example, the modules illustrated in FIG. 1 for processing. Data previously gathered is used to define the fault vectors that were described above with respect to, for example, the database 145 or the set 150 of previously-defined vectors of FIG. 1. In some embodiments, the data mining application is used to define the fault vector according to, for example, FIGS. 3, 4, or 5, based on previously-acquired data. Examples of suitable data mining applications include GENESIS® sold by Yield Dynamics, Inc. of Sunnyvale, Calif.; EXAMINATOR™ sold by Galaxy Semiconductor Solutions of Galway, Ireland; SIVISION® sold by LogicVision, Inc. of San Jose, Calif.; STATISTICA™ sold by StatSoft, Inc. of Tulsa, Okla.; MASTERMINER™ sold by Zaptron Systems, Inc. of Santa Clara, Calif.; or applications sold by PDF Solutions, Inc. of San Jose, Calif.

The above-described techniques can be implemented in digital electronic circuitry, or in computer hardware, firmware, software, or in combinations of them. The implementation can be as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communications, e.g., a communications network. Examples of communications networks, also referred to as communications channels, include a local area network (“LAN”) and a wide area network (“WAN”), e.g., the Internet, and include both wired and wireless networks. In some examples, communications networks can feature virtual networks or sub-networks such as a virtual local area network (“VLAN”). Unless clearly indicated otherwise, communications networks can also include all or a portion of the publicly-switched telephone network (“PSTN”), for example, a portion owned by a specific carrier.

While the invention has been particularly shown and described with reference to specific embodiments, it should be understood by those skilled in the art that various changes in form and detail may be made therein without departing from the spirit and scope of the invention as defined by the appended claims.

1. A method for classifying faults associated with a manufacturing process, the method comprising:
determining that a fault exists when at least one of a
(a) T² score, calculated based on a Hotelling-type calculation performed on a first subset of a plurality of manufacturing process-related variables, exceeds a predetermined T² critical value or,
(b) DModX score, calculated based on a DModX-type calculation performed on a second subset of the plurality of manufacturing process-related variables, exceeds a predetermined DModX critical value;
generating fault vectors for each of the calculation types performed in which the corresponding score exceeds the corresponding critical value;
comparing the generated fault vectors to a plurality of corresponding, previously-defined fault vectors to determine a comparison value indicative of a correlation between the generated fault vectors and the plurality of corresponding, previously-defined fault vectors; and
associating each of the generated fault vectors with at least one of a first class of vectors indicative of a known fault or a second class of vectors indicative of an unknown fault based in part on the comparison value.

2. A method for classifying a fault associated with a set of variables each associated with a manufacturing parameter, the method comprising:
defining a fault vector according to a multivariate analysis based on a contribution of a subset of the set of variables to a metric;
comparing the fault vector to a plurality of previously-defined vectors to determine a comparison value indicative of a correlation between the fault vector and the plurality of previously-defined vectors; and
associating the fault vector with at least one of a first set of fault vectors indicative of a known fault or a second set of fault vectors indicative of an unknown fault based in part on the comparison value.

3. The method of claim 2, wherein the step of associating comprises determining if a subset of values of the fault vector satisfies a predetermined criterion.

4. The method of claim 3, wherein the subset of values of the fault vector comprises values that contribute to the comparison value and the predetermined criterion comprises whether a calculation based on the subset of values of the fault vector is above a predetermined threshold.

5. The method of claim 3, wherein the subset of values of the fault vector comprises values that do not contribute to the comparison value and the predetermined criterion comprises whether a calculation based on the subset of values of the fault vector is below a predetermined threshold.

6. The method of claim 3, wherein the predetermined criterion is determined by a user.

7. The method of claim 2, wherein the manufacturing parameters are measured in a semiconductor wafer processing facility.

8. The method of claim 2, further comprising:
prior to defining the fault vector, determining the fault exists when a value, calculated based on a mathematical expression performed on the set of variables, exceeds a critical value.

9. The method of claim 2, further comprising:
prior to defining the fault vector, determining the fault exists when at least one of
(a) a first value, calculated based on a Hotelling-type calculation performed on the set of variables, exceeds a first critical value or
(b) a second value, calculated based on a DModX-type calculation performed on the set of variables, exceeds a second value.

10. The method of claim 9, wherein the metric comprises at least one of the first value, the second value or both.

11. The method of claim 2, wherein the comparison value is determined according to Pearson's correlation equation.

12. The method of claim 2, wherein the fault vector is associated with the first set of fault vectors when the comparison value exceeds a predetermined value.

13. The method of claim 12, wherein the predetermined value is determined by a user.

14. The method of claim 2, wherein the fault vector is associated with the second set of fault vectors when the comparison value does not exceed a predetermined value.

15. The method of claim 2, wherein the second set of fault vectors comprises an empty set before the fault vector is associated with the second set of fault vectors.

16. The method of claim 2, wherein associating the fault vector with the second set of fault vectors comprises establishing the second set of fault vectors.

17. The method of claim 2, further comprising assigning a statistical weight to the contribution to the metric of each member of the subset of the set of variables.

18. The method of claim 2, further comprising generating a model set of variables based on contributions from each member of a second set of variables used to define one or more previously-defined vectors selected from the plurality of previously-defined vectors.

19. The method of claim 2, further comprising determining an action to correct the fault based in part on whether the fault vector is associated with the first set of fault vectors or the second set of fault vectors.

20. The method of claim 2, further comprising associating a type of fault with the second set of fault vectors.

21. The method of claim 2, further comprising associating the fault vector with the plurality of previously-defined vectors.

22. A system for classifying a fault associated with a set of variables each associated with a manufacturing parameter, the system comprising:
a means for defining a fault vector according to a multivariate analysis based on a contribution of a subset of the set of variables to a metric;
a means for comparing the fault vector to a plurality of previously-defined vectors to determine a comparison value indicative of a correlation between the fault vector and the plurality of previously-defined vectors; and
a means for associating the fault vector with at least one of a first set of fault vectors indicative of a known fault or a second set of fault vectors indicative of an unknown fault based in part on the comparison value.

23. The system of claim 22, further comprising:
a means for determining the fault exists when at least one of a
(a) first value, calculated based on a Hotelling-type calculation performed on the set of variables, exceeds a first critical value or
(b) a second value, calculated based on a DModX-type calculation performed on the set of variables, exceeds a second critical value.

24. A computer program product, tangibly embodied in an information carrier, the computer program product including instructions being operable to cause data processing apparatus to:
define a fault vector according to a multivariate analysis based on a contribution to a metric of a subset of a set of variables each associated with a manufacturing parameter;
compare the fault vector to a plurality of previously-defined vectors to determine a comparison value indicative of a correlation between the fault vector and the plurality of previously-defined vectors; and
associate the fault vector with at least one of a first set of fault vectors indicative of a known fault or a second set of fault vectors indicative of an unknown fault based in part on the comparison value.

25. The computer program product of claim 24, further comprising instructions being operable to cause data processing apparatus to:
determine the fault exists when at least one of a
(a) first value, calculated based on a Hotelling-type calculation performed on the set of variables, exceeds a first critical value or
(b) a second value, calculated based on a DModX-type calculation performed on the set of variables, exceeds a second critical value.
